(19) United States
(12) Patent Application Publication
(10) Pub. No.: US 2009/0202127 A1
(43) Pub. Date: Aug. 13, 2009

(54) Method And System For Error Compensation

(75) Inventors: Matthias Bertram, Köln (DE); Jens Wiegert, Aachen (DE); Jan Timmer, Best (NL); Nicolaas Jan Noordhoek, Breda (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/305,983

(22) PCT Filed: Jun. 13, 2007
(86) PCT No.: PCT/IB2007/052243

§ 371 Date: Dec. 22, 2008

(30) Foreign Application Priority Data
Jun. 22, 2006 (EP) 06115861.4

(51) Int. Cl. G06K 9/00

(52) U.S. Cl. 382/131

(57) ABSTRACT

A method for generating a set of kernels for convolution error compensation of a projection image of a physical object recorded by an imaging system comprises calculating the set of kernels in such a way that for each pixel of the projection image an asymmetric scatter distribution for error compensation is calculated representing a X-ray scatter originating along a ray from an X-ray source to the pixel.

The invention relates to a method for generating a set of kernels, a method and a system for error compensation, a computer readable medium and a program element, in particular to a method for convolution-based error compensation of X-ray scatter.

Computed tomography (CT) is a process of using digital processing to generate a three-dimensional image of the internal of an object under investigation (object of interest, object under examination) from a series of two-dimensional x-ray images taken around a single axis of rotation. The reconstruction of CT images can be done by applying appropriate algorithms.

A basic principle of CT imaging is that projection data of an object under examination are taken by detectors of a CT system. The projection data represent information of the object passed by radiation beams. To generate an image out of the projection data these projection data (line integrals) can be back-projected leading to a two-dimensional image, i.e. representing a disc. Out of a plurality of such two-dimensional images a so-called voxel representation, i.e. a representation of three-dimensional pixels, can be reconstructed. In case that the detectors are already arranged in form of a plane, two-dimensional projection data are achieved and the result of the back-projection is a three-dimensional voxel. That is, in modern, more sophisticated so-called “cone-beam” CT and reconstruction methods the projection data of two-dimensional detectors, i.e. detectors having a plurality of detecting elements arranged in form of a matrix, are directly back-projected into a three-dimensional distribution of voxels in one single reconstruction step.

Scattered radiation is a major source of artifacts in cone-beam X-ray computed tomography. By causing artifacts such as noise, streaks and low-frequent inhomogeneities, so-called cupping, in reconstructed images, scatter impedes visibility of soft contrasts, i.e. portions having low contrasts. Especially in volume imaging using interventional X-ray systems where anti-scatter grids are inefficient, reliable and accurate retrospective methods for scatter compensation are needed. One approach for a correction are the so-called convolution based methods which are frequently used to estimate the scatter background in radiographic images. For example, such convolution based methods are described in “Computerized scatter correction in diagnostic radiology”, K. P. Maher and J. F. Malone, Contemporary Physics 38(2), 131-148, 1997.

Although these convolution based correction methods do increase the quality of the reconstructed images, the reconstructed images still exhibit artifacts, in particular in volumetric images.

It may be desirable to provide an alternative method for generating a set of kernels, a method and a system for error compensation, a computer readable medium and a program element which may exhibit greater accuracy in error compensation or may be less prone to artifacts in the reconstructed image.

This need may be met by a method for generating a set of kernels, a method and a system for error compensation, a computer readable medium and a program element according to the independent claims.

According to an exemplary embodiment of a method for generating a set of kernels for convolution error compensation of a projection image of a physical object recorded by an imaging system, the method comprises calculating the set of kernels in such a way that for each pixel of the projection image a generally asymmetric scatter distribution for error compensation is calculated representing the X-ray scatter originating in a volume defined by the beam between an X-ray source and the pixel.

According to an exemplary embodiment a method for error compensation of an image of a physical object comprises receiving an original projection image of an imaged physical object, converting the original projection image into a water-equivalent image (an image of water-equivalent thickness), extracting a number of scalar parameters from said water-equivalent image and possibly its gradient, determining at least one pre-calculated kernel according to an exemplary embodiment of the method for generating a set of kernels by relating the extracted parameters to the parameters of the pre-calculated kernels, and compensating an error of the original projection image by using the determined at least one pre-calculated kernel.

According to an exemplary embodiment a system for error compensation of an image of a physical object comprises a receiving unit adapted to receive an original projection image of an imaged physical object, a calculation unit adapted to convert the original projection image into a water-equivalent image, in particular calculate the corresponding gradient image, and to extract a number of parameters from the images of water-equivalent thickness and in particular of the gradient, an determination unit adapted to determine at least one pre-calculated kernel according to an exemplary embodiment of the method for generating a set of kernels by relating the extracted parameters to the parameters of the pre-calculated kernels, and a compensation unit adapted to compensate an error of the original projection image by using the determined at least one pre-calculated kernel.

According to an exemplary embodiment a tomography apparatus comprises a radiation source, a radiation detector, and a system for error compensating according to an exemplary embodiment, wherein the radiation detector is adapted to record data representing information of the original projection image of the imaged physical object.

According to an exemplary embodiment a computer readable medium is provided in which a program for error compensation of an image of a physical object is stored, which program, when executed by a processor, is adapted to control a method comprising: receiving an original projection image of an imaged physical object, converting the original projection image into a water-equivalent image, determining at least one pre-calculated kernel according to an exemplary embodiment of the method for generating a set of kernels by relating the extracted parameters to the parameters of the pre-calculated kernels, and compensating an error of the original projection image by using the determined at least one pre-calculated kernel.

According to an exemplary embodiment a program element for error compensation of an image of a physical object is provided, which program, when executed by a processor, is adapted to control a method comprising: receiving an original projection image of an imaged physical object, converting the original projection image into a water-equivalent image in particular calculate the corresponding gradient image, extracting a number of scalar parameters from said water-equivalent image and in particular from the gradient image, determining at least one pre-calculated kernel according to an exemplary embodiment of the method for generating a set of kernels by relating the extracted parameters to the parameters of the pre-calculated kernels, and compensating an error of the original projection image by using the determined at least one pre-calculated kernel according to an exemplary embodiment of the method for generating a set of kernels.

It may be seen as the gist of an exemplary embodiment of the present invention that a method for pre-calculating kernels is provided, which kernels adequately accounts for the asymmetry of scatter distributions generated along a ray, in dependence of the position where the ray penetrates the images object. One exemplary aspect of the present invention may be seen in that the present invention accurately accounts for the fact that a large fraction of detected scattered X-ray quanta may originate from regions near the boundary of the imaged physical object and that the scatter distribution generated along the path to such locations may be highly asymmetric. The exemplary embodiment may provide a correction scheme that may offer the potential to much more quantitatively estimate and correct for scatter in radiographic images and projections of cone-beam computer tomography (CT) acquisitions. Thereby, possibly reducing image artifacts and thus possibly enhancing low-contrast visibility, compared to a convolution-based method which does not take into account a dependence on the position where the ray penetrates the images object, e.g. whether the considered pixel relates to a centre of the physical object or to a border region. Preferably, the calculation of the set of kernels is done in such a way that for each pixel of the projection image an asymmetric scatter distribution for error compensation is calculated representing a X-ray scatter originating along a ray from an X-ray source to the pixel, wherein asymmetric may mean that no symmetry axis is existing. In particular, this asymmetry may be existing even in the case no anti-scatter grid is used.

The provided convolution-related scatter estimation scheme (not based on convolution in the strict mathematical sense) uses pre-calculated scatter kernels that determine the scatter contribution of a ray from the X-ray source to a detector element, depending on the object attenuation at that pixel, and on further properties derived from the projection image, such as estimates of the total object size or its maximal depth, or of the attenuation gradient in the water-equivalent image at said pixel. The total scatter image may be obtained by summing up the contributions of all such rays. The kernels may be generated either experimentally or numerically. These kernels may be usable in order to error compensating a projection image P⁽⁰⁾(x,y) which is comprised of a primary portion P and a scatter portion S, i.e. P⁽⁰⁾(x,y)=P(x,y)+S(x,y).

This reconstruction method may be usable in the field of tomography apparatuses, e.g. a computed tomography apparatus, in particular in an X-ray computer tomography.

In the following, further exemplary embodiments of the method for generating a set of kernels will be described. However, these embodiments apply also for the method and the system for error compensation, the tomography apparatus, the computer readable medium and the program element.

According to another exemplary embodiment of the method of generating a set of kernels the set of kernels is experimentally determined by using an X-ray phantom as a model. In particular, in the calculating of the set of kernels results of an experimental measurement might be used.

According to another exemplary embodiment of the method for generating a set of kernels the set of kernels is calculated by using scatter simulations of a geometric model, preferably assuming water-like scattering characteristics, or scattering characteristics of other materials. Preferably, each kernel of the set of kernels is a function of parameters of the geometric model.

That is, for the generation of pre-calculated kernels, normalized scatter distributions K(x,y) may be off-line generated using pencil-beam Monte-Carlo scatter simulations of the geometric model, which may be parameterized in such a way that it takes into account a correct system geometry, e.g. geometry of a tomography system, a correct beam spectrum, e.g. the energy spectrum of the corresponding radiation source of the tomography system, and a correct anti-scatter grid, e.g. whether an anti-scatter grid and which specific anti-scatter grid is used in the tomography system. From these scatter distributions an estimation of a scatter image S⁰(x,y) may be obtainable by summing up the pre-calculated contributions for rays impinging on the individual detector pixels in a projection image.

According to another exemplary embodiment of the method for generating a set of kernels at least one of the parameters is a radius of the geometric model. Preferably, the kernel is further a function of a shift between the projected centre of the geometric model and the position where the penetrating pencil beam impinges onto the detector.

That is, for a given system configuration, e.g. tomography system configuration, separate kernels K_{M,r,Φ}(x,y) may be off-line generated as a function of model parameters M, e.g. at least one radius, and as a function of a positional shift (r, Φ) of the model with respect to a pencil beam used for the simulation, wherein (r, Φ) are polar coordinates denoting the shift in a plane parallel to a detector plane of the tomography system. By calculating the kernels as a function of a positional shift (r, Φ) it may be possible to account for the scatter variation depending on the pixel location, e.g. whether the pixel is a boundary pixel or a centre pixel.

According to another exemplary embodiment of the method for generating a set of kernels the geometric model is an ellipsoidal model. Preferably, each kernel of the set of kernels is a function of r₁, r₂ and r₃ of the geometric model and of a shift r, Φ between the centre of the model and the position where the pencil beam penetrates the model possibly resulting in a shift between the projected centre of the geometric model and the position where the penetrating pencil beam impinges onto the detector, wherein r₁, r₂ and r₃ may be the half axes of the ellipsoidal model.

For these model parameter M, e.g. r₁, r₂, and r₃ the pre-calculated kernels may be calculated, i.e. the pre-calculated kernels K(x,y) may be calculated as a function of these model parameter M and as a function of a positional shift (r, Φ) of the model with respect to the pencil beam. For each combination of model parameters M=(r₁, r₂, r₃), scatter kernels K_{M,r,Φ}(x,y) may be generated under variation of the relative position between pencil beam and ellipsoid model in the plane parallel to the detector, wherein the positional shift of the model ellipsoid with respect to the pencil beam is denoted by the polar coordinates (r, Φ).

According to another exemplary embodiment of the method for generating a set of kernels the geometric model is a spherical model. Preferably, each kernel of the set of kernels is a function of a radius R of the spherical model and of a shift r,Φ between the centre of the model and the position where the pencil beam penetrates the model possibly resulting in a shift between the projected centre of the geometric model and the position where the penetrating pencil beam impinges onto the detector.

In the following, further exemplary embodiments of the method for error compensation will be described. However, these embodiments apply also for the method for generating a set of kernels, the system for error compensation, the tomography apparatus, the computer readable medium and the program element.

According to another exemplary embodiment of the method for error compensation the original projection image is normalized.

According to another exemplary embodiment of the method for error compensation each kernel of the set of kernels is a function of a geometry of the imaging system, a beam spectrum of the imaging system and/or anti-scatter grid parameters of the imaging system.

In this context “normalized” denotes the fact that the quantity P denotes the detected intensity of primary radiation normalized by the value for air, so that P=1 corresponds to direct radiation and P=0 corresponds to total absorption. By normalizing the projection image and converting it to a water-equivalent image it may be possible to provide for an efficient way to error compensating images by using pre-calculate kernels.

According to another exemplary embodiment of the method of error compensation the original projection image is converted into a water-equivalent image according

$$T ( x , y ) = \frac{- ln ( {P}^{( 0 )} ( x , y ) )}{μ} ,$$

wherein P⁽⁰⁾ represents the original projection image, T(x,y) represents the image of water-equivalent thickness T, and μ denoted the appropriate attenuation value of water.

In particular, generating a water-equivalent image may be suitable since water is predominant in a human being, thus leading to a simple but still sufficiently correct model.

According to another exemplary embodiment the method for error compensation further comprises calculating a total scatter at a given pixel of a pixel array by summing up the contributions of all kernels corresponding to all pixels.

Such a summing up of all contributions of all kernels may be an efficient way to calculate the effect of the total scattering contribution on the measured intensity at the given pixel, e.g. the intensity measured at a detector element of a computer tomography apparatus. This total scattering contribution may be afterwards used to compensate errors introduced to the projection image by scattering.

According to another exemplary embodiment of the method for error compensation the total scatter at a given pixel is defined by:

$${S}^{0} ( i , j ) = w \cdot {\sum }_{k , j} {K}_{M , r ( k , l ) , Φ ( k , l )} ( i - k , j - l ) ,$$

wherein: S⁰(i, j) is the total scatter at pixel (i,j), w denotes the area of the pixel, and K_{M,r(k,l),Φ(k,l)} (i−k, j−l) is the kernel indicative for the scattering introduced from a ray impinging at pixel (k,l) at the location of pixel (i,j) and depending on: M, which represents the parameters of a geometric model, and (r, Φ), which represents a positional shift of the geometric model with respect to a centre of the pixel array.

According to another exemplary embodiment of the method for error compensation for the calculation of the kernels an ellipsoidal model is used, wherein M represents the half axes r₁, r₂, r₃ of the ellipsoidal model, wherein r₁=r₂=sqrt(A/π) and r₃=B, with A=a maximum cross-sectional area of the physical object, and with B=a maximum thickness of the physical object.

The corresponding parameters r₁, r₂ and r₃ may be extractable from the projection image of the physical image and may represent the half axes of the ellipsoidal geometric model. Preferably, the projection image is converted into an image of water-equivalent thickness T according

$$T ( x , y ) = \frac{- ln ( {P}^{( 0 )} ( x , y ) )}{μ} ,$$

wherein P⁽⁰⁾ represents the original projection image, wherein T(x,y) represents the image of water-equivalent thickness T; and μ denoted the appropriate attenuation value of water. The parameter A may be specified as the area of the shadow of the physical object on the projection image, e.g. the region in the projection with attenuation above a certain threshold, divided by the square of the system's geometric magnification factor. The parameter B may be specified as the maximum of T(x,y) after low-pass filtering or as a percentile from a histogram of T, which both may minimize the influence of strong attenuation variations. In an alternative embodiment, the model parameters may be determined from a least squares fit of a forward projection of the model to the acquired projection.

It should be noted in this context that for a given model M, different shift values are equivalent to different values of the water-equivalent thickness at the pencil beam position, ranging from the maximal thickness of the model at zero shift down to almost zero thickness at shifts almost equal to the spatial extent of the model. In turn, for simple geometric models and a fixed shift angle Φ, a given value of water thickness T in the considered range unambiguously determines a corresponding value of r, so that in the interval (0,Tₘₐₓ], r(T) can be assumed to be a unique function.

For this embodiment, consider the scatter contribution of a ray impinging on the detector pixel with indices (k,l). At the location of another pixel (i,j), this ray produces a scatter contribution that is approximately described by the expression K_{M,r(T(k,l)),Φ(k,l)} (i−k, j−l), where for the utilized kernel the shift radius r is specified by the water thickness at pixel (k,l), and the shift angle Φ(k,l) might be chosen as the polar angle of pixel (k,l) in a coordinate system with origin at the “centre of attenuation mass” (c₁,c₂) specified as

$$( \begin{matrix}{c}_{1} \\ {c}_{2}\end{matrix} ) = \frac{1}{{\sum }_{k , l} T ( k , l )} \cdot {\sum }_{k , l} T ( k , l ) \cdot ( \begin{matrix}k \\ l\end{matrix} ) .$$

The total scatter at pixel (i,j) may then be obtained by summing up the contributions of all rays (k,l), yielding

$${S}^{0} ( i , j ) = w \cdot {\sum }_{k , j} {K}_{M , r ( T ( k , l ) ) , Φ ( k , l )} ( i - k , j - l ) ,$$

where the sum runs over all pixel (k,l) of the detector, and w denotes the pixel area.

According to another exemplary embodiment of the method for error compensation a spherical model is used for the calculation of the kernels, wherein the total scatter at the given pixel is defined by:

$${S}^{0} ( i , j ) = w \cdot {\sum }_{k , j} {K}_{R ( T ( k , l ) , g ( k , l ) ) , r ( T ( k , l ) g ( k , l ) ) , Φ ( k , l )} ( i - k , j - l ) ,$$

wherein S⁰(i,j) is the total scatter at pixel (i,j), w denotes the area of the pixel, and K_{R(T(k,l),g(k,l)),r(T(k,l)g(k,l)),Φ(k,l)} (i−k, j−l) is the kernel indicative for the scattering introduced from a ray impinging at pixel (k,l) at the location of pixel (i,j) and depending on: R, which represents a radius of the spherical geometric model, g, which represents a gradient of the corresponding image of water-equivalent thickness T, and (r, Φ), which represents a positional shift of the ellipsoidal geometric model with respect to a centre of the pixel array.

According to another exemplary embodiment the method for error compensation method the parameters R and r are chosen according

$$R = \frac{T}{4} \cdot \sqrt{4 + {g}^{2}}$$

and

$$r = \frac{T}{4} \cdot g$$

and Φ=arg(grad T), with T=a water-equivalent thickness of the physical object, and g=|grad T|.

According to this exemplary embodiment a spherical geometric model may be used, which may have a significant advantage in that it does not require estimation of global model parameters for each projection, but is based on local estimation of such parameters for each single ray. This variant uses spherical geometric models (phantoms) and, as the previously described variant, also works via phantom offsets with respect to the pencil beam.

Applied to a projection P, the method first may require to calculate the gradient of the corresponding image of water-equivalent thickness T=−(ln P)/μ, which for each detector element exhibits a certain value of magnitude g=|grad T| and direction Φ=arg(grad T). To estimate the scatter contribution of a given source ray, the local values of water-equivalent thickness T, gradient magnitude g and direction Φ then uniquely may determine the parameters (R, r, Φ) of the utilized sphere phantom, where R may denote the radius of the sphere, and (r, Φ) may be its positional offset in the plane parallel to the detector. The mapping (T, g) [symbol] (R, r) is done in such a way that a parallel projection of the utilized sphere would exhibit a water-equivalent thickness T and a thickness gradient g at the position of the pencil beam. This is achieved by the following equations:

$$R = \frac{T}{4} \cdot \sqrt{4 + {g}^{2}} , r = \frac{T}{4} \cdot g .$$

It should be noted that in this way, the positional offset will be close to zero in flat image areas, while it becomes close to the sphere radius at steep gradients, e.g. near the object border. Using this method, for a given system geometry and beam quality, the convolution kernels are pre-calculated depending on the three parameters (R, r, Φ) as compared to four parameters in case of the method based on ellipsoid models (kernels).

Such a spherical model may be in particular efficient when the projection image is affected by truncations, e.g. in case the physical object is larger than the possible imaged object. While the ellipsoidal model may be affected by an erroneous estimation of the model parameter r₁=r₂ due to this truncations, the method based on sphere kernels may be not affected by truncations, due to its localized estimation of model parameters.

According to another exemplary embodiment the method further comprises calculating a first error compensated image in a multiplicative way by using the total scatter. Preferably, the multiplicative correction is performed according:

$${P}^{( n + 1 )} = \frac{{P}^{( 0 )} \cdot {P}^{( n )}}{{P}^{( n )} + {S}^{( n )}} ,$$

wherein S⁽ⁿ⁾ denotes the scatter image estimated from the projection image P⁽ⁿ⁾.

The multiplicative way may in particular advantageous, since it may exhibit an increased stability of convergence and may have the additional advantage that negative projection values are avoided. Using the latter correction scheme, assuming the same estimated scatter, in regions with high attenuation a smaller amount of scatter may be corrected for as compared to regions with low attenuation. In contrast to subtractive correction where a pre-defined threshold on the maximal subtracted amount of scatter may be specified in order to avoid negative projection values, such effects may be automatically avoided using multiplicative correction. In contrast to subtractive correction, multiplicative correction may need to be performed on full resolution projection images and therefore, in each iteration the estimated coarse scatter distributions may be again at least partly upsampled before applying the correction step.

According to another exemplary embodiment the method further comprises calculating a first error compensated image in a subtractive way by using the total scatter. Preferably, the subtractive correction is performed according: P⁽ⁿ⁺¹⁾=P⁽⁰⁾−S⁽ⁿ⁾, wherein S⁽ⁿ⁾ denotes the scatter image estimated from the projection image P⁽ⁿ⁾.

According to another exemplary embodiment the method further comprises calculating a second error compensated image by using the first error compensated image as the projection image. That is, the correction may be performed in an iterative way, e.g. in 4 to 5 repetitions. That is, after estimation of a scatter image S⁽⁰⁾(x,y), this image is then used to correct the originally acquired projection image P⁽⁰⁾(x,y) (containing both contributions of primary and scattered radiation), yielding an estimate P⁽¹⁾(x,y) of the true primary image. Because the initial scatter-deteriorated projection image P⁽⁰⁾ results in a somewhat falsified thickness image T, estimation and correction steps are preferably repeated a number of times in an iterative fashion, until convergence of the estimated primary image is reached (this may usually achieved in about 4-5 iterations). Since scatter distributions are smooth, scatter estimation may be carried out using a strongly down-sampled detector pixel grid in order to decrease computational effort.

One exemplary aspect of the present invention may be seen in that a variable offset of the utilized phantoms is introduced during kernel generation. The schemes based on ellipsoid kernels and on sphere kernels make use of such an offset, and thus are potentially able to appropriately account for the asymmetry of scatter distributions produced near the object boundaries. Both estimation schemes may have high potential for application in X-ray volume imaging. Especially the scheme based on pre-calculated sphere kernels may produce accurate results for different body regions (e.g., head, thorax and pelvis regions), and its performance may not be affected by the presence of truncations. Most importantly, the optimal correction factors for these body regions may almost be the same. Regarding computational costs, the sphere method may be somewhat more demanding than the ellipsoidal methods, since the scatter kernels of all possible sphere configurations are preferably read and simultaneously stored in memory. For most efficient use of this method, this data may be kept in memory instead of repeatedly being read when the method is applied to a sequence of projections of a rotational acquisition.

In order to improve the method based on ellipsoid kernels, which my be affected by truncations when applied to the projections of thorax and pelvis, it may be possible to more robustly estimating the model parameters via an optimization algorithm using forward projection of the model, which might also be separately applicable to each acquired projection. This is due to the fact that this method relies on at least approximate estimation of two global parameters per projection, one of which is difficult to estimate in case of truncations.

Furthermore, according to one exemplary aspect of the invention two different schemes for the correction step of scatter compensation have been considered, namely subtractive and multiplicative correction. Each scheme can be combined with each of the scatter estimation algorithms according to exemplary embodiments. While subtractive correction may casually produce clipping-related streak artifacts and may suffer from unsatisfactory stability of the iterative estimation-correction procedure, it may be less computational time consuming. Alternatively, multiplicative correction may produce in all cases favourable results. Since multiplicative correction possibly needs to be performed on higher resolution projection images, in each iteration estimated coarse scatter distributions may be again up-sampled before applying the correction step.

The error compensation of a projection image of a physical object may be realized by a computer program, i.e. by software, or by using one or more special electronic optimization circuits, i.e. in hardware, or in hybrid form, i.e. by software components and hardware components. The computer program may be written in any suitable programming language, such as, for example, C++ and may be stored on a computer-readable medium, such as a CD-ROM. Also, the computer program may be available from a network, such as the WorldWideWeb, from which it may be downloaded into image processing units or processors, or any suitable computers.

It should be noted in this context, that the present invention is not limited to computed tomography, but may include the use of C-arm based 3D rotational X-ray imaging, positron emission tomography or the like. It should also be noted that this technique may in particular be useful for medical imaging of different body regions such as a head, a thorax or a pelvic region of a patient.

These and other aspects of the present invention will become apparent from and elucidated with reference to the embodiment described hereinafter. The disclosed embodiments and aspects described anywhere in this application may be mixed and/or combined with each other.

An exemplary embodiment of the present invention will be described in the following, with reference to the following drawings.

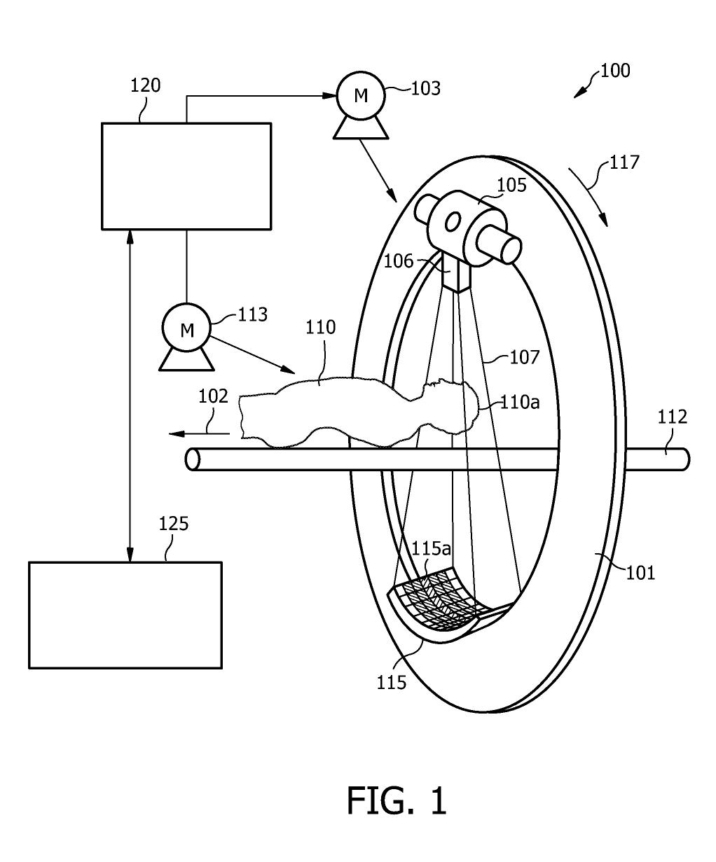

FIG. 1 shows a simplified schematic representation of a computed tomography system.

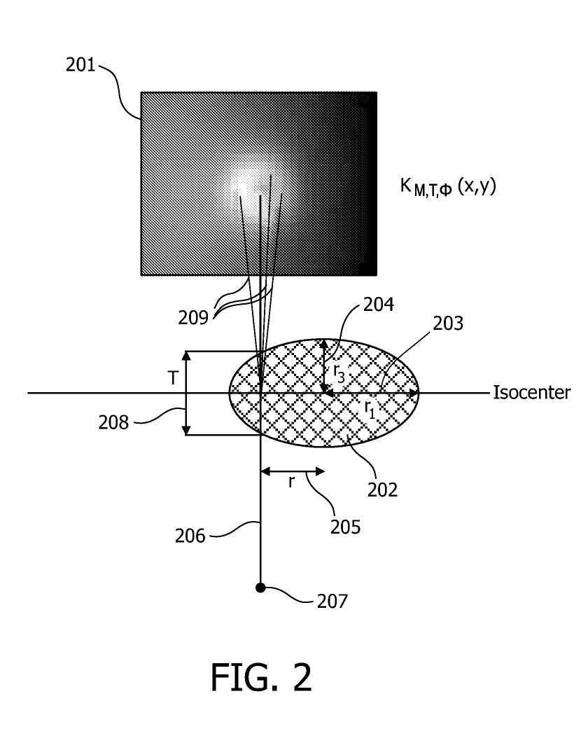

FIG. 2 shows a schematic sketch of a geometry for generation of an ellipsoidal kernel.

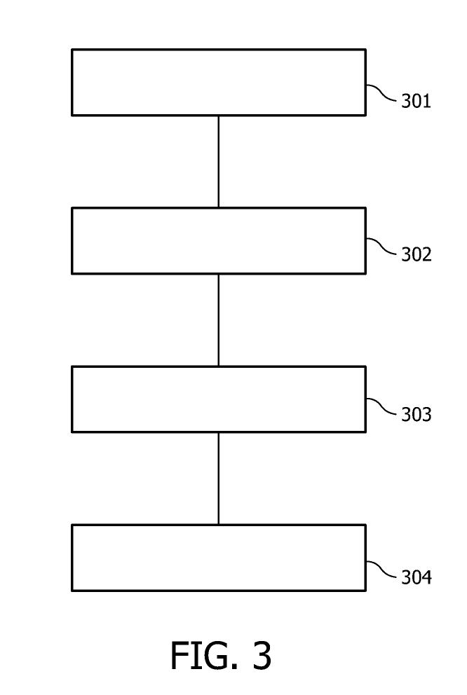

FIG. 3 shows a schematic flow chart of an error compensation method according to an exemplary embodiment of the invention.

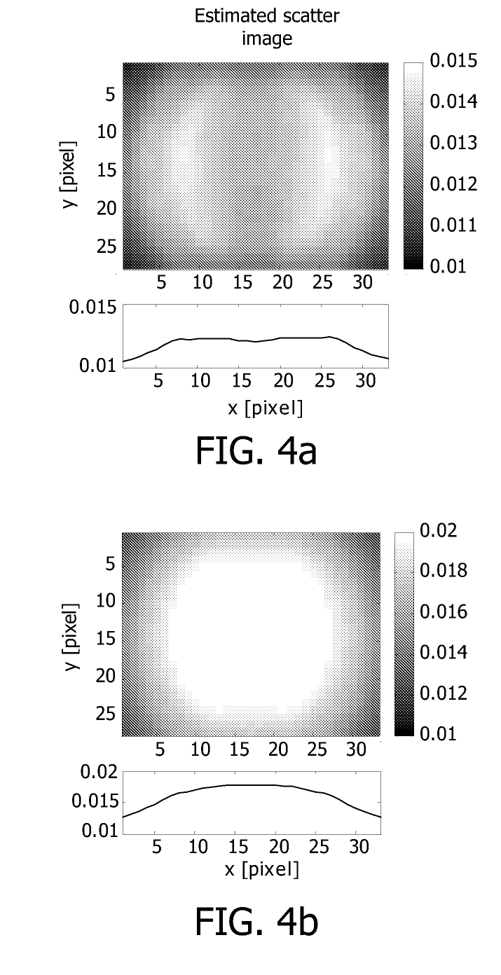

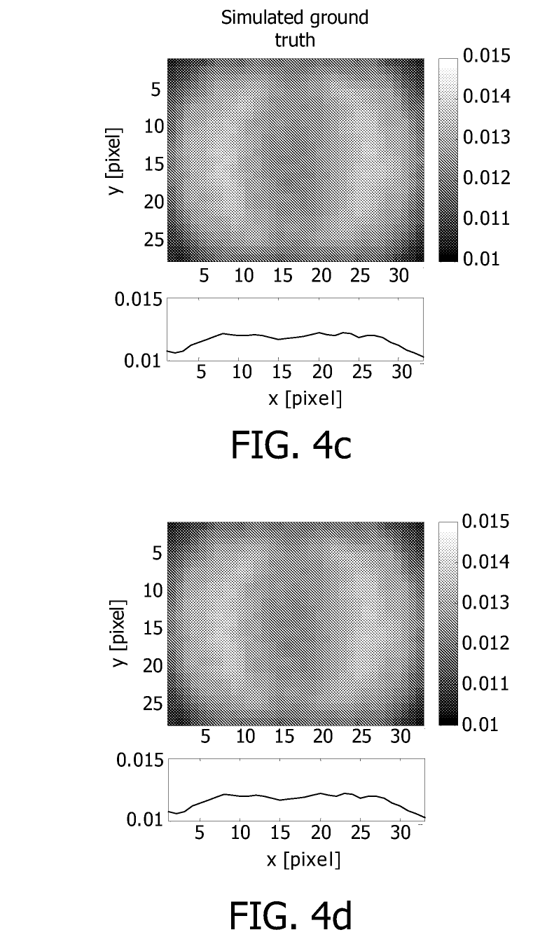

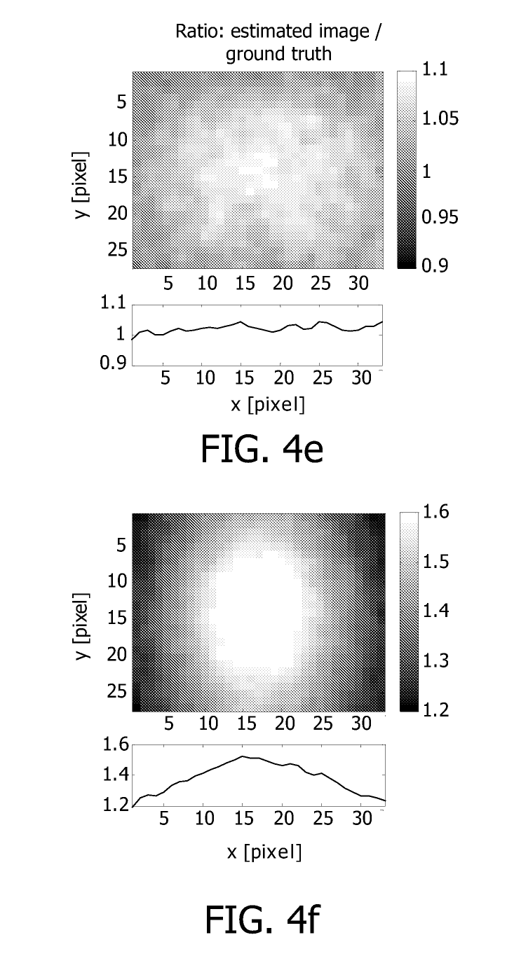

FIG. 4 shows some exemplary scatter images.

The illustration in the drawings is schematically. In different drawings, similar or identical elements are provided with the similar or identical reference signs.

FIG. 1 shows an exemplary embodiment of a computed tomography scanner system which projection data may be handled by a correction method according an embodiment of the invention.

The computed tomography apparatus 100 depicted in FIG. 1 is a cone-beam CT scanner. The CT scanner depicted in FIG. 1 comprises a gantry 101, which is rotatable around a rotational axis 102. The gantry 101 is driven by means of a motor 103. Reference numeral 105 designates a source of radiation such as an X-ray source, which emits polychromatic or monochromatic radiation.

Reference numeral 106 designates an aperture system which forms the radiation beam emitted from the radiation source unit to a cone-shaped radiation beam 107. The cone-beam 107 is directed such that it penetrates an object of interest 110 arranged in the center of the gantry 101, i.e. in an examination region of the CT scanner, and impinges onto the detector 115 (detection unit). As may be taken from FIG. 1, the detector 115 is arranged on the gantry 101 opposite to the radiation source unit 105, such that the surface of the detector 115 is covered by the cone beam 107. The detector 115 depicted in FIG. 1 comprises a plurality of detection elements 115a each capable of detecting X-rays which have been scattered by, attenuated by or passed through the object of interest 110. The detector 115 schematically shown in FIG. 1 is a two-dimensional detector, i.e. the individual detector elements are arranged in a plane, such detectors are used in so-called cone-beam tomography.

During scanning the object of interest 110, the radiation source unit 105, the aperture system 106 and the detector 115 are rotated along the gantry 101 in the direction indicated by an arrow 117. For rotation of the gantry 101 with the radiation source unit 105, the aperture system 106 and the detector 115, the motor 103 is connected to a motor control unit 120, which is connected to a control unit 125 (which might also be denoted and used as a calculation, reconstruction or determination unit).

In FIG. 1, the object of interest 110 is a human being which is disposed on an operation table 112. During the scan of a head 10a, a thorax or any other part of the human being 110, while the gantry 101 rotates around the human being 110, the operation table 112 may displace the human being 110 along a direction parallel to the rotational axis 102 of the gantry 101. This may be done using a motor 113. By this, the head is scanned along a helical scan path. The operation table 112 may also be stopped during the scans to thereby measure signal slices.

The detector 115 is connected to the control unit 125. The control unit 125 receives the detection result, i.e. the read-outs from the detection elements 115a of the detector 115 and determines a scanning result on the basis of these read-outs. Furthermore, the control unit 125 communicates with the motor control unit 120 in order to coordinate the movement of the gantry 101 with motors 103 and 113 with the operation table 112.

The control unit 125 may be adapted for reconstructing an image from read-outs of the detector 115. A reconstructed image generated by the control unit 125 may be output to a display (not shown in FIG. 1) via an interface.

The control unit 125 may be realized by a data processor or computer to process read-outs from the detector elements 115a of the detector 115.

The computed tomography apparatus shown in FIG. 1 may capture computed tomography data of the head or thorax of a patient. In other words, when the gantry 101 rotates and when the operation table 112 is shifted linearly, then a helical scan is performed by the X-ray source 105 and the detector 115 with respect to the patient. After having acquired these data, the data are transferred to the control unit 125, and the measured data may be analyzed retrospectively.

FIG. 2 shows a schematic sketch of a geometry for generation of an ellipsoidal kernel. By referring to this sketch an exemplary embodiment of ellipsoid kernels with variable offsets will be described. This method accounts for the fact that the scatter contribution originating from regions near the borders of the imaged object is highly asymmetric (e.g. object centre versus border region), while in known methods no offset between scattering ray and model is used, and therefore the asymmetry of the produced scatter contribution is generally not accurately accounted for.

According to the ellipsoidal model the projection image P(x,y) is first normalized and then converted into an equivalent image of water-equivalent thickness T(x,y) according to the formula T=−(ln P)/μ, where μ denotes the approximate attenuation value of water.

Afterwards, two scalars are extracted from the image of water-equivalent thickness T, specifying parameters of an ellipsoid-shaped model of the imaged object with water-like attenuation and scattering characteristics. In particular, the homogeneous ellipsoid is assumed to have half axes r₁=r₂=sqrt(A/π) in the plane parallel to the detector surface, and a half axis r₃=Tₘₐₓ/2 perpendicular to the detector. Here, A is a measure of the cross-sectional area of the imaged object parallel to the detector surface and is specified as the area of the object shadow (defined as the region in the projection with water-equivalent thickness above a certain threshold, e.g. 10 mm) divided by the square of the system's geometric magnification factor. The quantity Tₘₐₓ is the approximate measure of largest water-equivalent thickness. For calculation of scatter kernels accounting for the important dependence on the pixel position, known water slabs were replaced by the ellipsoid model, and additionally positional offsets of the model with respect to the simulated pencil beam were considered. For each combination of model parameters M=(r₁, r₂, r₃), scatter kernels K_{M,r,Φ}(x,y) were generated under variation of the relative position between pencil beam and ellipsoid model in the plane parallel to the detector, wherein the positional shift of the model ellipsoid with respect to the pencil beam is denoted by the polar coordinates (r, Φ). It should be noted in this context that for a given model M, different shift values are equivalent to different values of the water-equivalent thickness at the pencil beam position, ranging from the maximal thickness of the model at zero shift down to almost zero thickness at shifts almost equal to the spatial extent of the model. In turn, for a fixed shift angle f, a given value of water thickness T in the considered range unambiguously determines a corresponding value of r, so that in the interval (0,Tₘₐₓ], r(T) is a unique function. The geometry used for generation of ellipsoid kernels is illustrated in FIG. 2.

FIG. 2 shows a flat detector 201 comprising columns x and rows y. On the detector the detected scatter distribution of a ray penetrating an ellipsoid model is schematically depicted by the white field on the flat detector 201. It can be seen that the detected scatter is highly asymmetric, i.e. the effect of scattering is much higher on the left half of the flat detector 201 than on the right half of the flat detector 201, leading to brighter pixels left from the centre. Further, FIG. 2 shows in a schematically shape the water ellipsoid 202 used to generate the ellipsoid kernels K_{M,r,Φ}(x,y). The ellipsoid 202 is characterized by several parameters, in particular the half axes r₁ 203, r₃ 204, while r₂ is not depicted in FIG. 2 since it extends perpendicular to the plane shown in FIG. 2. Furthermore a nonzero positional shift r 205 is marked in FIG. 2, i.e. a nonzero shift of the focal line 206, which extends from the focal spot 207 to the centre of the flat detector 201, and the centre of the water ellipsoid 202. As r₂ the shift angle Φ is not shown in FIG. 2, since it is defined in a plane parallel to the detector surface. The water thickness T is depicted as 208 in FIG. 2, while lines 209 schematically show different scattered rays.

Using the model- and position-dependent kernels K_{M,r,Φ}(x,y), the scatter contribution of a ray impinging on the detector pixel with indices (k,l) at the location of another pixel (i,j) is given by the expression K_{M,r(T(k,l)),Φ(k,l)} (i−k, j−l), where the length r of the positional shift for the utilized kernel is specified via the water thickness at pixel (k,l), and the shift angle Φ(k,l) is chosen as the polar angle of pixel (k,l) in a coordinate system with origin at the “centre of attenuation mass” (c₁,c₂) specified as

$$( \begin{matrix}{c}_{1} \\ {c}_{2}\end{matrix} ) = \frac{1}{{\sum }_{k , l} T ( k , l )} \cdot {\sum }_{k , l} T ( k , l ) \cdot ( \begin{matrix}k \\ l\end{matrix} ) .$$

This may provide a suitable orientation of the asymmetric scatter kernel distributions in case a single, approximately ellipsoid-shaped object. The total scatter at pixel (i,j) is then obtainable by summing up the contributions of all rays (k,l) yielding the expression

$${S}^{0} ( i , j ) = w \cdot {\sum }_{k , j} {K}_{M , r ( T ( k , l ) ) , Φ ( k , l )} ( i - k , j - l ) .$$

The geometry for sphere kernel generation is the same as the one depicted in FIG. 2, except that r₁=r₂=r₃=R, i.e. instead of a water ellipsoid a water sphere is used. However, the offset may be calculated differently.

FIG. 3 shows a schematic flow chart of an error compensation method according to an exemplary embodiment of the invention. This embodiment in particular relates to an ellipsoidal geometric model. The method processes each acquired projection image separately and may comprise the following sequence:
1. An acquired normalized projection image P⁽⁰⁾(x,y)=P(x,y)+S(x,y) comprised of a primary portion P and a scattered portion S is converted into an image of water-equivalent thickness T according to T=−(ln P⁽⁰⁾ (x, y))/μ, where μ denoted the appropriate attenuation value of water (Step 301).
2. From the image T, a number of scalar parameters are extracted, specifying the parameters of a simple geometric model of the imaged object. For instance, the half axes rᵢ of a homogeneous ellipsoidal object model with circular cross-section parallel to the detector plane and water-like attenuation may be calculated according to, e.g. r₁=r₂=sqrt(A/π) and r₃=B, with scalars A and B. In this particular embodiment, i.e. the ellipsoid case, A is an approximate measure of the maximum cross-sectional area of the imaged object parallel to the detector surface, and B is an appropriate measure of the maximum water-equivalent thickness of the imaged object. A may be specified as the area of the object shadow, e.g. the region in the projection with attenuation above a certain threshold, divided by the square of the system's geometric magnification factor. To minimize the influence of localized strong attenuation variations, B may be specified as the maximum of T(x,y) after low-pass filtering or as a percentile from a histogram of T. In an alternative embodiment, the model parameters are determined from a least square fit of a forward projection of the model to the acquired projection (Step 302).
3. An estimation of the scattered image S⁽⁰⁾(x,y) is obtained by summing up pre-calculated scatter contributions for the rays impinging on the individual detector pixels. For this purpose, normalized scatter distributions K(x,y) are off-line generated using pencil-beam Monte-Carlo scatter simulations of the parametric object model, taking into account the correct system geometry, beam spectrum, and anti-scatter grid parameters. For a given system configuration, separate kernels K_{M,r,Φ}(x,y) are off-line generated as a function of model parameters M and, to account for the important dependence on pixel position relative to the projected object centre, as a function of a positional shift (r, Φ) of the model with respect to the pencil beam, wherein(r, Φ) are polar coordinates denoting the shift in the plane parallel to the detector. It is important to note that for a given model M, different shift values are equivalent to different values of the water-equivalent thickness at the pencil beam position, ranging from the maximal thickness of the model at zero shift down to almost zero thickness at shifts almost equal to the spatial extent of the model. In turn, for simple geometric models and a fixed shift angle Φ, a given value of water thickness T in the considered range unambiguously determines a corresponding value of r, so that in the interval (0,Tₘₐₓ], r(T) can be assumed to be a unique function.

Now, the scatter contribution of a ray impinging on the detector pixel with indices (k,l) can be considered. At the location of another pixel (i,j), this ray produces a scatter contribution that is approximately described by the expression K_{M,r(T(k,l)),Φ(k,l)} (i−k, j−l), where for the utilized kernel the shift radius r is specified by the water thickness at pixel (k,l), and the shift angle Φ(k,l) might be chosen as the polar angle of pixel (k,l) in a coordinate system with origin at the “centre of attenuation mass” (c₁,c₂) specified as

$$( \begin{matrix}{c}_{1} \\ {c}_{2}\end{matrix} ) = \frac{1}{{\sum }_{k , l} T ( k , l )} \cdot {\sum }_{k , l} T ( k , l ) \cdot ( \begin{matrix}k \\ l\end{matrix} ) .$$

The total scatter at pixel (i,j) is then obtained by summing up the contributions of all rays (k,l), yielding

$${S}^{0} ( i , j ) = w \cdot {\sum }_{k , j} {K}_{M , r ( T ( k , l ) ) , Φ ( k , l )} ( i - k , j - l ) ,$$

where the sum runs over all pixel (k,l) of the detector, and w denotes the pixel area (Step 303).
4. Using the estimated scatter S⁰(x,y), the acquired projection image P⁽⁰⁾(x,y) is then corrected, yielding an estimate P⁽¹⁾(x,y) of the true primary image (Step 304). Because the initial scatter-deteriorated projection image P⁽⁰⁾ results in a somewhat falsified thickness image T, best results are achieved when 1. to 4. (Steps 301 to 304) are repeated about four times in an iterative fashion until convergence of the estimated primary image is reached, wherein the repetition of 2. (Step 302) is optional. Since scatter distributions are smooth, the above steps may be carried out using a strongly down-sampled detector pixel grid in order to decrease computational effort.

Correction may either be performed in a subtractive or in a multiplicative way. Subtractive corrections in iteration n (n>1) is carried out according to the formula P⁽ⁿ⁺¹⁾=P⁽⁰⁾−S⁽ⁿ⁾. However, multiplicative correction according

$${P}^{( n + 1 )} = \frac{{P}^{( 0 )} \cdot {P}^{( n )}}{{P}^{( n )} + {S}^{( n )}}$$

was found to increase stability of convergence and has the additional advantage that negative projection values are avoided.

FIG. 4 shows some exemplary scatter images. In the upper figures of FIG. 2 results of a error correction method according to an exemplary embodiment of the present invention are shown in particular an ellipsoid model, whereas the lower figures of FIG. 2 show results of a known method based on pre-calculated scatter kernels, which does not use a positional offset of the model and thus does not accurately account for the asymmetric scatter contributions especially of the rays near the object borders. In detail, FIG. 4a shows in the upper part an estimated scatter image depicted for a two-dimensional detector having rows y and columns x. In the lower part of FIG. 4a the corresponding profile along the central horizontal cross-section through the image is displayed. FIG. 4b shows in the upper part the estimated scatter image depicted for a two-dimensional detector having rows y and columns x. In the lower part of FIG. 4b the corresponding profile along the central horizontal cross-section through the image is displayed.

FIG. 4c shows in the upper part a simulated ground truth depicted for a two-dimensional detector having rows y and columns x. In the lower part of FIG. 4a the corresponding profile along the central horizontal cross-section through the image is displayed. FIG. 4d depicts the same for the known method. FIGS. 4c and 4d are the same since the same ground truth is used for the comparison.

FIG. 4e shows in the upper part the ration of estimated image to ground truth in a two-dimensional plot having rows y and columns x. It can be clearly seen that the mean ratio is about 1 but still showing a slightly overestimation of about 5% while the scatter shape is well approximated, which can be seen from the relatively uniform distribution of the greyscale values. On contrary, FIG. 4f shows a highly non-uniformly distribution. In particularin the image centre, corresponding to the area of greatest thickness of the object, the scattering is highly overestimated, while the overestimation is much lower near the borders. In mean the overestimation is about 44%.

In the test implementation, the computational effort of the correction method according to an exemplary embodiment of the invention was only about twice as high than for the known convolution-based approaches, the results of which are depicted in the lower part of FIG. 4. In general the correction method according to an exemplary embodiment of the invention may allow for potentially much more accurate estimation of the scatter distribution, due to the fact that the dependence of scattering on further parameters than only the water-equivalent thickness is accounted for. It should be noted that the term “comprising” does not exclude other elements or steps and the “a” or “an” does not exclude a plurality. Also elements described in association with different embodiments may be combined. It should also be noted that reference signs in the claims shall not be construed as limiting the scope of the claims.

1. A method for generating a set of kernels for convolution error compensation of a projection image of a physical object recorded by an imaging system, the method comprising:
calculating the set of kernels in such a way that for each pixel of the projection image an asymmetric scatter distribution for error compensation is calculated representing a X-ray scatter originating in a volume defined by the beam between an X-ray source and the pixel.

2. The method according claim 1,
wherein the set of kernels is experimentally determined by using an X-ray phantom as a model.

3. The method according to claim 1,
wherein the set of kernels is calculated by using scatter simulations of a geometric model.

4. The method according to claim 2,
wherein each kernel of the set of kernels is a function of parameters of the geometric model.

5. The method according to claim 4,
wherein at least one of the parameters is a radius of the geometric model.

6. The method according to claim 4,
wherein the kernel is further a function of a shift between the projected centre of the geometric model and the position where the penetrating pencil beam impinges onto the detector.

7. The method according to claim 2,
wherein the geometric model is an ellipsoidal model.

8. The method according to claim 7,
wherein each kernel of the set of kernels is a function of r1, r2 and r3 of the geometric model, and of a shift r,Φ between the centre of the model and the position where the pencil beam penetrates the model.

9. The method according to claim 2,
wherein the geometric model is a spherical model.

10. The method according to claim 9,
wherein each kernel of the set of kernels is a function of a radius R of the spherical model and a shift r,Φ between the centre of the model and the position where the pencil beam penetrates the model.

11. The method according to claim 1,
wherein each kernel of the set of kernels is a function of a geometry of the imaging system, a beam spectrum of the imaging system and/or anti-scatter grid parameters of the imaging system.

12. A method for error compensation of an image of a physical object, the method comprising:
receiving an original projection image of an imaged physical object;
converting the original projection image into a water-equivalent image, in particular calculating the corresponding gradient image;
extracting a number of parameters from the images of water-equivalent thickness and in particular from the gradient image;
determining at least one pre-calculated kernel according to claim 1 by relating the extracted parameters to the parameters of the pre-calculated kernels; and
compensating an error of the original projection image by using the determined at least one pre-determined kernel.

13. The method according claim 12,
wherein the original projection image is normalized.

14. The method according claim 12,
wherein the original projection image is converted into a water-equivalent image according
$$T ( x , y ) = \frac{- ln ( {P}^{( 0 )} ( x , y ) )}{μ} ,$$
wherein P(0) represents the original projection image,
T(x,y) represents the image of water-equivalent thickness T; and
μ denotes the appropriate attenuation value of water.

15. The method according to claim 12, further comprising:
calculating a total scatter at a given pixel of an pixel array by summing up the contribution of all kernels corresponding to all pixels.

16. The method according to claim 15
wherein the total scatter at the given pixel is defined by:
$${S}^{0} ( i , j ) = w \cdot {\sum }_{k , j} {K}_{M , r ( T ( k , l ) ) , Φ ( k , l )} ( i - k , j - l ) ,$$
wherein:
S⁰(i,j) is the total scatter at pixel (i,j),
w denotes the area of a pixel, and
K_{M,r(T(k,l)),Φ(k,l)} (i−k, j−l) is the kernel indicative for the scattering introduced from a ray impinging at pixel (k,l) at the location of pixel (i,j) and depending on:
M which represents the parameters of the geometric model; and
(r,Φ) which represents a positional shift of the ellipsoidal geometric model with respect to a centre of the pixel array.

17. The method according to claim 16
wherein for the calculation of the kernels an ellipsoidal model is used; and
wherein M represents the half axes r1, r2, r3 of the ellipsoidal model
wherein r1=r2=sqrt(A/π) and r3=B,
with A=a maximum cross-sectional area of the physical object, and
B=a maximum thickness of the physical object.

18. The method according to claim 15
wherein for the calculation of the kernels a spherical model is used; and
wherein the total scatter at the given pixel is defined by:
$${S}^{0} ( i , j ) = w \cdot {\sum }_{k , j} {K}_{R ( T ( k , l ) , g ( k , l ) ) , r ( T ( k , l ) g ( k , l ) ) , Φ ( k , l )} ( i - k , j - l ) ,$$
wherein:
S⁰(i,j) is the total scatter at pixel (i,j),
w denotes the area of the pixel, and
K_{R(T(k,l),g(k,l)),r(T(k,l)g(k,l)),Φ(k,l)} (i−k, j−l) is the kernel indicative for the scattering introduced from a ray impinging at pixel (k,l) at the location of pixel (i,j) and depending on:
R which represents a radius of the spherical geometric model;
g which represents a gradient of the corresponding image of water-equivalent thickness T, and
(r,Φ) which represents a positional shift of the ellipsoidal geometric model with respect to a centre of the pixel array.

19. The method of claim 18,
wherein
$$R = \frac{T}{4} \cdot \sqrt{4 + {g}^{2}} and r = \frac{T}{4} \cdot g$$
and Φ=arg(grad T),
with T=a water-equivalent thickness of the physical object, and g=|grad T|.

20. The method according to claim 16, further comprising:
calculating a first error compensated image in a multiplicative way by using the total scatter.

21. The method according claim 20, further comprising:
performing the multiplicative correction according
$${P}^{( n + 1 )} = \frac{{P}^{( 0 )} \cdot {P}^{( n )}}{{P}^{( n )} + {S}^{( n )}} ,$$
wherein
S(n) denotes the scatter image estimated from the projection image P(n).

22. The method according to claim 16, further comprising:
calculating a first error compensated image in a subtractive way by using the total scatter.

23. The method according claim 22, further comprising:
performing the multiplicative correction according:
P⁽ⁿ⁺¹⁾=P⁽⁰⁾−S⁽ⁿ⁾, wherein
S(n) denotes the scatter image estimated from the projection image P(n).

24. The method according to claim 20, further comprising:
calculating a second error compensated image by using the first error compensated image as the projection image.

25. A system for error compensation of an image of a physical object, the system comprising:
a receiving unit adapted to receive an original projection image of an imaged physical object;
a calculation unit adapted to convert the original projection image into a water-equivalent image, in particular to calculate the corresponding gradient image, and to extract a number of parameters from the images of water-equivalent thickness and in particular from the gradient image;
a determination unit adapted to determine at least one pre-calculated kernel according to claim 1 by relating the extracted parameters to the parameters of the pre-calculated kernels; and
a compensation unit adapted to compensate an error of the original projection image by using the determined at least one pre-calculated kernel.

26. A tomography apparatus comprising:
a radiation source;
a radiation detector; and
a system for error compensating according claim 25;
wherein the radiation detector is adapted to record data representing the original projection image of the imaged physical object.

27. A computer readable medium in which a program for error compensation of an image of a physical object is stored, which program, when executed by a processor, is adapted to control a method comprising:
receiving an original projection image of an imaged physical object;
converting the original projection image into a water-equivalent image, in particular calculating the corresponding gradient image;
extracting a number of parameters from the images of water-equivalent thickness and in particular from the gradient image;
determining at least one pre-calculated kernel according to claim 1 by relating the extracted parameters to the parameters of the pre-calculated kernels; and
compensating an error of the original projection image by using the determined at least one pre-calculated kernel.

27. A program element for error compensation of an image of a physical object, which program, when executed by a processor, is adapted to control a method comprising:
receiving an original projection image of an imaged physical object;
converting the original projection image into a water-equivalent image, in particular calculating the corresponding gradient image;
extracting a number of parameters from the images of water-equivalent thickness and in particular from the gradient image;
determining at least one pre-calculated kernel according to claim 1 by relating the extracted parameters to the parameters of the pre-calculated kernels; and
compensating an error of the original projection image by using the determined at least one pre-calculated kernel.
